(19) United States
(12) Patent Application Publication
(10) Pub. No.: US 2026/0203917 A1
(43) Pub. Date: Jul. 16, 2026

(54) POSE TRACKING METHOD AND SYSTEM, MOBILE DEVICE, ELECTRONIC DEVICE AND STORAGE MEDIUM

(71) Applicant: QUALCOMM Incorporated, San Diego, CA (US)

(72) Inventors: Wentao MAO, Beijing (CN); Xu ZHANG, Beijing (CN); Wenjie MOU, San Diego, CA (US)

(21) Appl. No.: 19/135,344

(22) PCT Filed: Jan. 4, 2024
(86) PCT No.: PCT/CN2024/070545

§ 371 Date: Jun. 3, 2025

(30) Foreign Application Priority Data
Jan. 12, 2023 (CN) 202310063756.X

(51) Int. Cl. G06T 7/246; G06F 3/03; G06F 3/0346; G06T 7/277; G06T 7/73

(52) U.S. Cl. CPC G06T 7/251; G06F 3/0325; G06F 3/0346; G06T 7/277; G06T 7/75; G06T 2207/20081; G06T 2207/20084; G06T 2207/30204

(57) ABSTRACT

A pose tracking method and system, a mobile device, an electronic device and a storage medium. The pose tracking method includes: acquiring an image of a mobile device whereon is disposed with a light emitting unit for emitting signal light; based on the image, extracting, as a reference feature, a light spot feature corresponding to the light emitting unit on the image, and extracting a two-dimensional feature point corresponding to a three-dimensional feature point of the mobile device in the image; obtaining an initialization pose of the mobile device based on the two-dimensional feature point; and based on the initialization pose and the at least two reference features, optimizing the initialization pose for fine-tuning the initialization pose, to make the light spot feature corresponding to the initialization pose coincide with the reference feature. According to the embodiments of the present invention, the precision of pose tracking is improved, and the number of light emitting units required is reduced, such that a structure is simplified, and power consumption is reduced.

### TECHNICAL FIELD

Embodiments of the present invention relate to the technical field of virtual reality, and particularly to pose tracking method and system, mobile device, electronic device and storage medium.

### BACKGROUND

Six degrees of freedom mobile devices (such as handheld controllers) are important implementation means of virtual reality apparatuses for human-computer interaction. The types of sensors used by the 6 degrees of freedom handheld controller may be categorized as optical, electromagnetic and ultrasonic. A handheld controller pose tracking system based on an optical sensor is high in precision and good in robustness, and is one of the most dominant implementations.

The main principle of the 6 Degrees of Freedom (6 DoF) tracking of an optical handheld controller is that a camera detects an infrared light spot on a handheld member, solves a 6 Degrees of Freedom pose of the handheld member by using a classical Perspective-n-Point (PnP) algorithm, and fuses the pose with data of an Inertial Measurement Unit (IMU), so as to obtain smooth and low-latency pose information.

However, the current mobile device is large in power consumption, and the precision of pose tracking needs to be improved.

### SUMMARY

The problem to be solved by embodiments of the present invention is to provide pose tracking method and system, mobile device, electronic device and storage medium, so as to improve the precision of pose tracking, reduce the number of light emitting units required, and reducing power consumption.

In order to solve the above problems, the embodiments of the present invention provide a pose tracking method, which comprises: acquiring an image of a mobile device whereon is disposed with a light emitting unit for emitting signal light; based on the image, extracting, as a reference feature, a light spot feature corresponding to the light emitting unit on the image, and extracting a two-dimensional feature point corresponding to a three-dimensional feature point of the mobile device in the image; obtaining an initialization pose of the mobile device based on the two-dimensional feature point; and based on the initialization pose and the at least two reference features, optimizing the initialization pose for fine-tuning the initialization pose, to make the light spot feature corresponding to the initialization pose coincide with the reference feature.

Accordingly, the embodiments of the present invention further provide a pose tracking system, which comprises: an image acquiring module configured to acquire an image of a mobile device whereon is disposed with a light emitting unit for emitting signal light; a feature extraction module configured to, based on the image, extract, as a reference feature, a light spot feature corresponding to the light emitting unit on the image, and extract a two-dimensional feature point corresponding to a three-dimensional feature point of the mobile device in the image; an initialization calculating module configured to obtain an initialization pose of the mobile device based on the two-dimensional feature point; and a pose optimizing module configured to, based on the initialization pose and the at least two reference features, optimize the initialization pose for adjusting the initialization pose, to make the light spot feature corresponding to the initialization pose coincide with the reference feature.

Accordingly, the embodiments of the present invention further provide a mobile device, and pose information of the mobile device is calculated by using the pose tracking method provided by the embodiments of the present invention; and the mobile device comprises: a positioning component on which a plurality of light emitting units for emitting signal light are distributed, and the light emitting units are configured to be able to see at least two light emitting units from various angles simultaneously.

Accordingly, the embodiments of the present invention further provide an electronic device, which comprises at least one memory and at least one processor; and the memory stores one or more computer instructions, wherein the one or more computer instructions are executed by the processor to implement the pose tracking method provided by the embodiments of the present invention.

Accordingly, the embodiments of the present invention further provide a storage medium; the storage medium stores one or more computer instructions; and the one or more computer instructions are used for implementing the pose tracking method provided by the embodiments of the present invention.

Compared with the existing technology, the technical solutions of the embodiments of the present invention have the following advantages:

According to the pose tracking method provided by the embodiments of the present invention, the feature of the light emitting unit is extracted as the reference feature based on the image, and the feature points on the mobile device are extracted; the initialization pose of the mobile device is obtained based on the two-dimensional feature point; based on the initialization pose and the at least two reference features, the initialization pose is optimized for fine-tuning the initialization pose, to make the feature of the light emitting unit corresponding to the initialization pose coincide with the reference feature, and the optimized initialization pose is used as the pose information of the mobile device; the precision of pose tracking is improved by first obtaining the initialization pose based on the two-dimensional feature point and then optimizing the initialization pose based on the initialization pose and the at least two reference features; furthermore, the initialization pose is calculated without depending on or entirely depending on the light spot feature corresponding to the light emitting unit, and during the process of optimizing the initialization pose, a minimum of two reference features are only required, such that the number of the light emitting units required on the mobile device is reduced, thereby simplifying the structure of the mobile device, reducing power consumption, and improving the design diversity of the mobile device.

In the pose tracking system provided by the embodiments of the present invention, the feature extraction module extracts the feature of the light emitting unit as the reference feature based on the image, and extracts the feature point on the mobile device; the initialization calculating module obtains the initialization pose based on the two-dimensional feature point, and the pose optimizing module optimizes the initialization pose based on the initialization pose and the at least reference features, such that the precision of pose tracking is improved; furthermore, the initialization calculating module does not depend on or not entirely depend on the light spot feature corresponding to the light emitting unit when calculating the initialization pose, and during the process that the pose optimizing module optimizes the initialization pose, a minimum of two reference features are only required, such that the number of the light emitting units required on the mobile device is reduced, thereby simplifying the structure of the mobile device, reducing power consumption, and improving the design diversity of the mobile device.

### BRIEF DESCRIPTION OF THE DRAWINGS

FIGS. 1 to 4 are schematic structural diagrams of two handheld control trackers;

FIG. 5 is a flowchart corresponding to a handheld member 6 degrees of freedom positioning method;

FIG. 6 is a schematic diagram of an output result of a deep neural network of an improved YOLO architecture in FIG. 5;

FIG. 7 is a flowchart of an embodiment of a pose tracking method of the present invention;

FIG. 8 is a schematic structural diagram of an embodiment of a mobile device of the present invention;

FIG. 9 is a flowchart of an embodiment of step S2 in FIG. 7;

FIG. 10 is a schematic structural diagram of an embodiment of a deep learning network of step S22 in FIG. 9;

FIG. 11 is a schematic diagram of a process of an embodiment in which inference is performed in step S23 in FIG. 9;

FIG. 12 is a schematic diagram of a process of an embodiment in which optimization is performed in step S4 in FIG. 7;

FIG. 13 is a functional block diagram of an embodiment of a pose tracking system of the present invention;

FIG. 14 is a schematic structural diagram of another embodiment of a mobile device of the present invention;

FIG. 15 is a schematic structural diagram of yet another embodiment of a mobile device of the present invention;

FIG. 16 is a schematic diagram of two use states of a mobile device of the present invention; and

FIG. 17 is a hardware structure diagram of an electronic device provided by an embodiment of the present invention.

### DETAILED DESCRIPTION

From BACKGROUND, it can be learned that, the current mobile device is large in power consumption, and the precision of pose tracking needs to be improved.

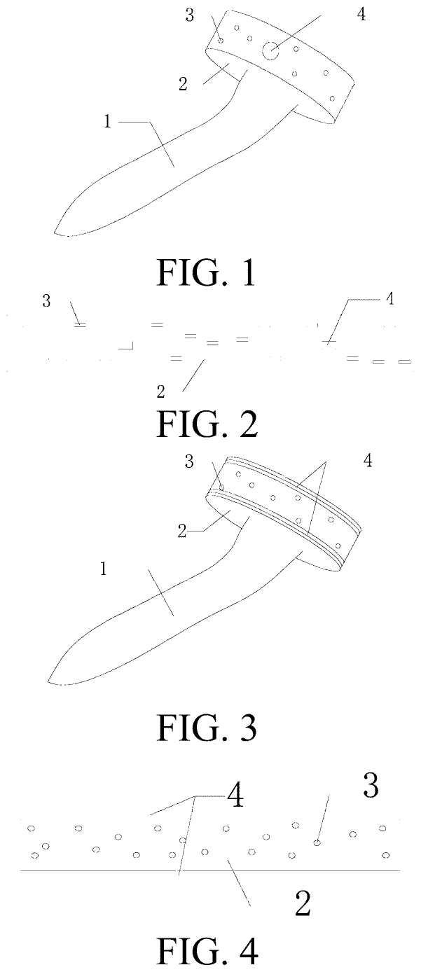

By using a mobile device being a handheld controller as an example, FIGS. 1 to 4 are schematic structural diagrams of two handheld control trackers. FIG. 1 is a schematic structural diagram of a first handheld control tracker, and FIG. 2 is a schematic diagram when a first surface is unfolded in FIG. 1; and FIG. 3 is a schematic structural diagram of a second handheld control tracker, and FIG. 4 is a schematic diagram when a first surface is unfolded in FIG. 3.

The handheld control tracker shown in FIGS. 1 to 4 comprises a handheld member body 1 and a light emitting unit 2; the light emitting unit 2 is disposed on an end of the handheld member body 1, and forms a preset angle with the handheld member body 1; the light emitting unit 2 comprises a first surface, a second surface, a plurality of first light emitting markers 3, and a plurality of second light emitting markers 4, and the second surface covers the first surface; the first light emitting markers 3 and the second light emitting markers 4 are all disposed on the first surface, and the plurality of first light emitting markers 3 are distributed in a ring; the first light emitting markers 3 and the second light emitting markers 4 are configured to be lit to be captured by an imaging apparatus; and the first light emitting markers 3 are lit at a first time period, and the second light emitting markers 4 are lit at a second time period.

For the handheld control tracker shown in FIGS. 1 to 4, tracking in a complex background environment is completed by designing a complex light emitting rule, all light emitting markers cannot be simultaneously lit, and the handheld control tracker shown in FIGS. 1 to 4 employs a traditional pose tracking algorithm, such that more light emitting markers are required to ensure that the sufficient number of light emitting markers may be seen at each angle, for example, greater than or equal to 4, so as to guarantee the accuracy of pose estimation of a handheld member; thus more light emitting markers are required by the handheld control tracker shown in FIGS. 1 to 4, which increases hardware costs and overall weight, and easily leads to excessive power consumption and complex circuit design.

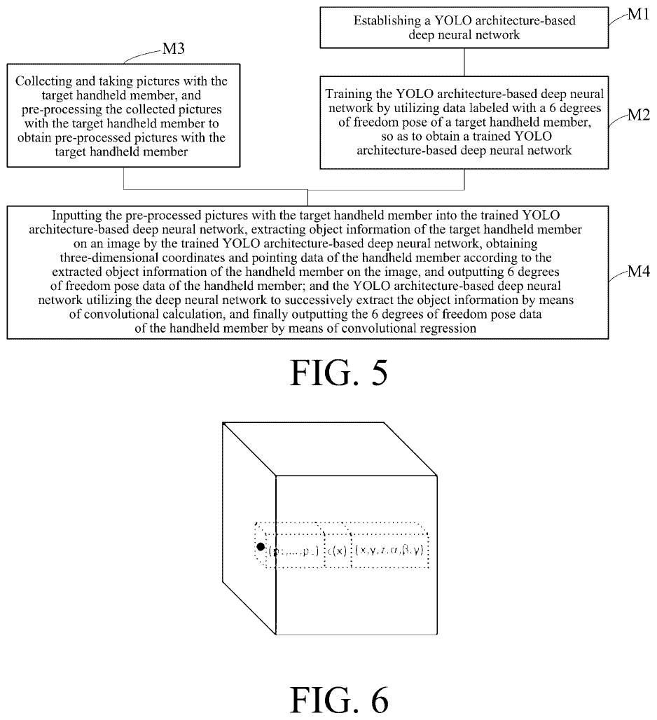

FIG. 5 is a flowchart corresponding to a handheld member 6 degrees of freedom positioning method. FIG. 6 is a schematic diagram of an output result of a deep neural network of an improved YOLO architecture in FIG. 5. A positioning method shown in FIG. 5 comprises:
Step M1: establishing a You Only Look Once (YOLO) architecture-based deep neural network;
Step M2: training the YOLO architecture-based deep neural network by utilizing data labeled with a 6 degrees of freedom pose of a target handheld member, so as to obtain a trained YOLO architecture-based deep neural network;
Step M3: collecting and taking pictures with the target handheld member, and pre-processing the collected pictures with the target handheld member to obtain pre-processed pictures with the target handheld member; and
Step M4: inputting the pre-processed pictures with the target handheld member into the trained YOLO architecture-based deep neural network, extracting object information of the target handheld member on an image by means of the trained YOLO architecture-based deep neural network, obtaining three-dimensional coordinates and pointing data of the handheld member according to the extracted object information of the handheld member on the image, and outputting 6 degrees of freedom pose data of the handheld member; and utilizing the deep neural network to successively extract the object information by means of convolutional calculation based on the YOLO architecture-based deep learning network, and finally outputting the 6 degrees of freedom pose data of the handheld member by means of convolutional regression.

The positioning method shown in FIG. 5 uses the YOLO architecture-based deep neural network, obtains the three-dimensional coordinates and pointing data of the handheld member according to the extracted object information of the handheld member on the image, and outputs the 6 degrees of freedom pose data of the handheld member, that is, as shown in FIG. 6, an input is a handheld member image, and an output comprises 6 degrees of freedom (x, y, z, α, β, γ), whether the handheld member is in a visual field (c(x)), and the category of the handheld member (p1 . . . pc).

However, according to the positioning method shown in FIG. 5, a precise three-dimensional feature cannot be directly extracted according to a visual feature of the handheld controller in the image, resulting in low precision of the outputted 6 degrees of freedom, and IMU data is not fused, causing high frame rate tracking to be unavailable.

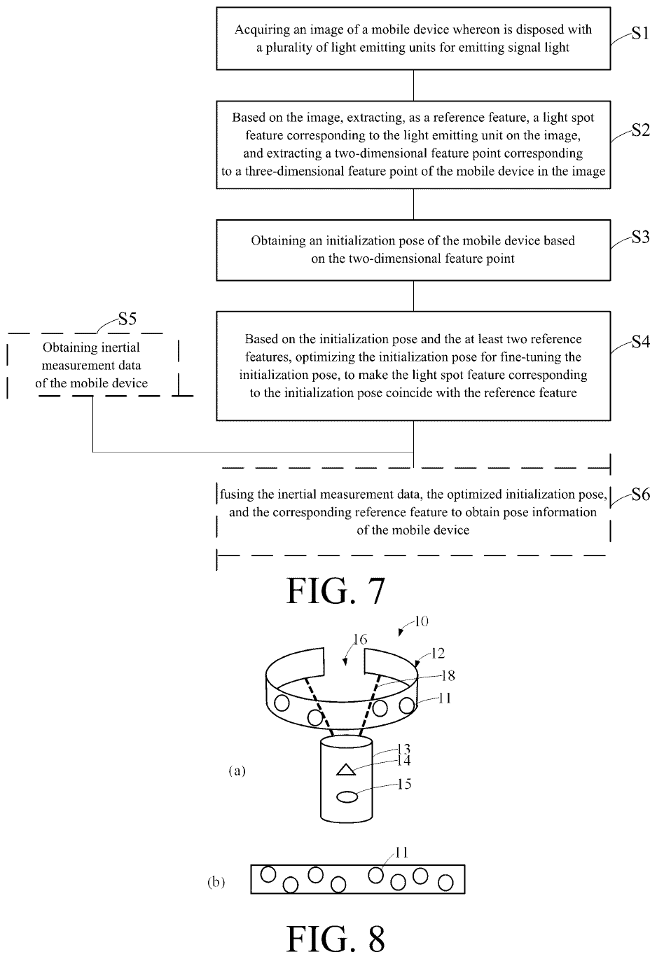

In order to resolve the technical problem, the embodiments of the present invention provide a pose tracking method. FIG. 7 is a flowchart of an embodiment of a pose tracking method of the present invention.

Referring to FIG. 7, in this embodiment, the pose tracking method comprises the following basic steps:
Step S1: acquiring an image of a mobile device whereon is disposed with a plurality of light emitting units;
Step S2: based on the image, extracting, as a reference feature, a light spot feature corresponding to the light emitting unit on the image, and extracting a two-dimensional feature point corresponding to a three-dimensional feature point of the mobile device in the image;
Step S3: obtaining an initialization pose of the mobile device based on the two-dimensional feature point; and
Step S4: based on the initialization pose and the at least two reference features, optimizing the initialization pose for fine-tuning the initialization pose, to make the light spot feature corresponding to the initialization pose coincide with the reference feature.

In the above-mentioned pose tracking method, the feature of the light emitting unit is extracted as the reference feature based on the image, the feature points on the mobile device are extracted, the initialization pose is obtained based on the two-dimensional feature point, and then the initialization pose is optimized based on the initialization pose and the at least two reference features, such that the precision of pose tracking is improved; furthermore, the initialization pose is calculated without depending on or entirely depending on the light spot feature corresponding to the light emitting unit, and during the process of optimizing the initialization pose, a minimum of two reference features are only required, such that the number of the light emitting units required on the mobile device is reduced, thereby simplifying the structure of the mobile device, reducing power consumption, and improving the design diversity of the mobile device.

In order to make the above purposes, features and advantages of the present invention more obvious and readily understood, particular embodiments of the present invention are described below in detail with reference to the drawings. In combination with FIG. 8, FIG. 8 is a schematic structural diagram of an embodiment of a mobile device of the present invention. FIG. 8(a) is a schematic diagram of a three-dimensional structure of a mobile device, and FIG. 8(b) is a schematic diagram of a positioning component shown in FIG. 8(a) unfolded along a surface of the positioning component.

Referring to FIGS. 7 and 8, step S1 of acquiring the image of the mobile device 10 whereon is disposed with the light emitting unit 11 for emitting signal light is executed.

The image of the mobile device 10 is acquired for subsequent tracking of a pose of the mobile device 10 at an image time based on the image. In particular, the light spot feature corresponding to the light emitting unit 11 on the image is subsequently extracted based on the image, and the two-dimensional feature point corresponding to the three-dimensional feature point of the mobile device 10 in the image is extracted. Accordingly, the image comprises a light spot corresponding to the light emitting unit 11.

The mobile device 10 is an apparatus that can move and is to be subjected to pose tracking. In this embodiment, the plurality of light emitting units 11 are disposed on the mobile device 10, and the light emitting unit 11 is configured to emit the signal light to form the corresponding light spot in the image, such that the light spot feature corresponding to the light emitting unit 11 is extracted subsequently based on the image.

In particular, referring to FIG. 8, in this embodiment, the mobile device 10 comprises a positioning component 12, and the plurality of light emitting units 11 are distributed on the positioning component 12. The positioning component 12 is configured to mount and distribute the light emitting units 11.

As an example, the mobile device 10 is a handheld controller. For example, the mobile device 10 is the handheld controller applied to VR, AR or MR.

In this embodiment, the handheld controller comprises a lamp ring, that is, the positioning component 12 of the handheld controller is of an annular structure, and the lamp ring is provided with the plurality of light emitting units 11. During particular implementation, the light emitting unit 11 may be an LED lamp. In other embodiments, the mobile device may also be other mobile pose tracking apparatus with LED lamps or reflective balls.

During particular implementation, the mobile device 10 is configured to be cooperatively used with a tracking display device (not shown in the figure), and the tracking display device is configured to collect the image of the mobile device 10, and calculate the pose of the mobile device 10 based on the collected image; and the tracking display device is also provided with a display end, and the pose of the mobile device 10 is obtained subsequently, such that display content of the display end is updated based on pose information of the mobile device 10.

For example, the mobile device 10 is the handheld controller applied to VR, AR or MR, and the tracking display device is a head-mounted display apparatus cooperatively used with the handheld controller. In particular, the head-mounted display apparatus may be a pair of VR, AR or MR smart glasses.

As an example, the image of the mobile device 10 is acquired by an image acquisition device disposed on the tracking display device. As an example, the image acquisition device may be a camera unit. During particular implementation, the camera unit may be an infrared (IR) camera, a grayscale camera, a color camera, etc. During particular implementation, there may be one or more camera units.

Continuously referring to FIG. 7, Step S2 of, based on the image, extracting, as the reference feature, the light spot feature corresponding to the light emitting unit 11 on the image, and extracting the two-dimensional feature point corresponding to the three-dimensional feature point of the mobile device 10 in the image, is executed.

The light spot feature corresponding to the light emitting unit 11 on the image is extracted, such that, after the initialization pose is subsequently obtained, the initialization pose can be optimized based on the initialization pose and the at least two reference features. During the process of optimization, the at least two reference features are used as reference baseline for the light spot feature corresponding to the initialization pose, such that the light spot feature corresponding to the initialization pose can coincide with the reference feature.

During particular implementation, the light spot is generally circular or oval-shaped. The light spot feature comprises shapes of various light spots, such that positions of the light spots and the distribution of the light spots are determined.

The two-dimensional feature point corresponding to the three-dimensional feature point of the mobile device 10 in the image is used for calculating the initialization pose of the mobile device 10, such that the initialization pose can be calculated subsequently without depending on or entirely depending on the light spot feature corresponding to the light emitting unit 11, thereby reducing the number of the light emitting units 11 required on the mobile device 10.

In this embodiment, the three-dimensional feature point refers to a feature point corresponding to the mobile device 10 in a three-dimensional space, and is used for marking a position and state of the mobile device 10 in the three-dimensional space. Accordingly, the two-dimensional feature point refers to a feature point corresponding to the three-dimensional feature point in the acquired image of the mobile device 10.

In this embodiment, a selection method of the three-dimensional feature point comprises: taking, as the three-dimensional feature point, each vertex of a smallest three-dimensional bounding frame of a three-dimensional model of the mobile device 10. The three-dimensional bounding frame refers to a cuboid bounding frame that surrounds the mobile device 10.

According to a shape rule of the smallest three-dimensional bounding frame, a position of the vertex is easily determined and calculated, and in this embodiment, the two-dimensional feature point corresponding to the three-dimensional feature point in the image is easily determined by selecting each vertex of the smallest three-dimensional bounding frame, and the initialization pose is easily calculated subsequently based on the two-dimensional feature point.

In other embodiments, the three-dimensional feature point may also be a point on the mobile device, and the selection method of the three-dimensional feature point may further comprise: selecting a plurality of pivotal points on the three-dimensional model of the mobile device as the three-dimensional feature points. In this embodiment, the number of the three-dimensional feature points is at least four, so as to meet a number requirement for calculating a smallest feature point of the initialization pose.

For example, when the mobile device comprises the positioning component, the positioning component is distributed with the plurality of light emitting units, the positioning component is of the annular structure, and one or more notches are provided at positions other than the light emitting units on the positioning component, a corner vertex of the notch may be selected as the three-dimensional feature point. In some other embodiments, other pivotal points on the mobile device may also be selected as the three-dimensional feature points based on an actual shape of the mobile device and actual requirements.

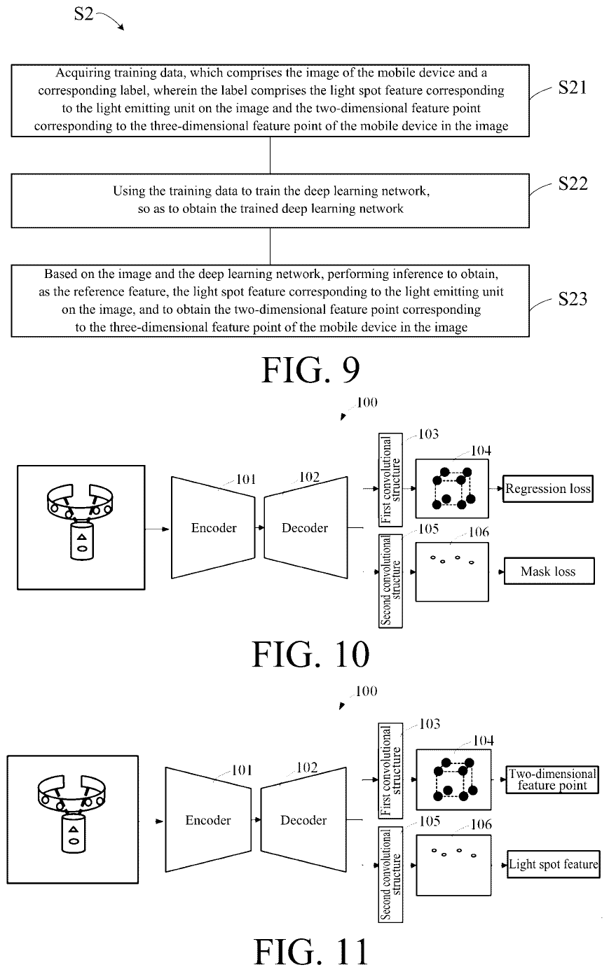

FIG. 9 shows a flowchart of an embodiment of step S2 in FIG. 7.

Step S2 of, based on the image, extracting, as the reference feature, the light spot feature corresponding to the light emitting unit 11 on the image, and extracting the two-dimensional feature point corresponding to the three-dimensional feature point of the mobile device 10 in the image, is described in detail below in combination with FIG. 9 in this embodiment.

As shown in FIG. 9, step S21: acquiring training data, which comprises the image of the mobile device 10 and a corresponding label, wherein the label comprises the light spot feature corresponding to the light emitting unit 11 on the image and the two-dimensional feature point corresponding to the three-dimensional feature point of the mobile device 10 in the image.

The training data is used for subsequently training the deep learning network to obtain the trained deep learning network, so as to subsequently acquire the light spot feature and the two-dimensional feature point by means of the trained deep learning network. As an example, during particular implementation, an automatic labeling system or a manual labeling system may be used to generate the training data.

Referring to FIGS. 9 and 10, step S22: using the training data to train the deep learning network 100 (as shown in FIG. 10), so as to obtain the trained deep learning network 100. The trained deep learning network 100 is configured to subsequently extract the reference feature and the two-dimensional feature point.

As an example, FIG. 10 is a schematic structural diagram of an embodiment of a deep neural network 100 of step S22 in FIG. 9, a structure of the deep learning network 100 comprises: an encoder 101 for inputting the image of the mobile device; a decoder 102 connected with an output of the encoder 101; a first convolutional structure 103 connected with an output of the decoder 102; a feature point feature extraction module 104 for outputting a predicted coordinate value of the two-dimensional feature point; a second convolutional structure 105 connected with the output of the decoder 102; and a light spot feature extraction module 106 for outputting the light spot feature.

As an example, the encoder 101 may select a network structure such as a residual neural network (Resnet), repvgg, mobilenet, etc. As an example, the decoder 102 uses a deconvolution structure, which is configured to improve feature resolution extracted by the encoder 101.

During particular implementation, there may be a short connection structure between the decoder and the encoder, and the short connection structure refers to a plurality of connection layers or addition layers during deep learning, and is configured to realize the combination of a decoder feature and an encoder feature.

During particular implementation, the deep learning network may be trained by using an optimizer such as an adaptive moment estimation (Adam) optimizer, a Stochastic Gradient Descent (SGD) optimizer, etc.

In particular, in combination with FIG. 10, in this embodiment, using the training data to train the deep learning network comprises: calculating, as a regression loss, a residual between the predicted coordinate value of the two-dimensional feature point and a true value of the coordinate value of the two-dimensional feature point; calculating, as a mask loss, a residual between the output light spot feature and a real light spot feature; and using a loss function L=L0+αL1 to train the deep learning network, wherein L0 is the mask loss, L1 is the regression loss, and α is a weight of the regression loss function in the loss function.

In this embodiment, when the deep learning network is trained, the extraction of the light spot feature and the regression of the two-dimensional feature point are trained together, such that information can be additionally provided to the deep learning network by using a multi-task structure, thereby improving a feature extraction effect under a complex scenario.

During particular implementation, when the deep learning network is trained by using the training data, a plurality of data augmentation methods may be used, and the extraction of the light spot feature and the regression of the two-dimensional feature point are trained together, such that a training dataset is increased to make the dataset to be as diverse as possible, so as to make a trained model have a stronger generalization capability.

Referring to FIGS. 9 and 11, FIG. 11 is a schematic process diagram of an embodiment of an inference process in step S23 in FIG. 9, step S23 of, based on the image and the deep learning network, performing inference to obtain, as the reference feature, the light spot feature corresponding to the light emitting unit on the image, and to obtain the two-dimensional feature point corresponding to the three-dimensional feature point of the mobile device in the image, is executed.

In this embodiment, the light spot feature corresponding to the light emitting unit 11 on the image and the two-dimensional feature point are obtained by means of the deep learning network, such that the information can be additionally provided to the deep learning network by using the multi-task structure, thereby improving the feature extraction effect under the complex scenario.

In particular, as shown in FIG. 11, the image is inputted into the trained deep learning network, and then the light spot feature and the two-dimensional feature point are outputted.

Referring to FIG. 7, Step S3 of obtaining the initialization pose of the mobile device 10 based on the two-dimensional feature point is executed. The initialization pose is obtained so as to subsequently optimize the initialization pose, such that the precision of pose tracking is improved.

In this embodiment, the initialization pose is calculated without depending on or entirely depending on the light spot feature corresponding to the light emitting unit 11, such that the number of the light emitting units 11 required on the mobile device 10 is reduced.

In this embodiment, the step of obtaining the initialization pose of the mobile device 10 based on the two-dimensional feature point comprises: based on a corresponding relationship between the two-dimensional feature point and the three-dimensional feature point, using a Perspective-n-Point (PnP) algorithm to obtain the initialization pose of the mobile device 10.

Referring to FIG. 7, Step S4 of, based on the initialization pose and the at least two reference features, optimizing the initialization pose for fine-tuning the initialization pose, to make the light spot feature corresponding to the initialization pose coincide with the reference feature, is executed.

In this embodiment, the precision of pose tracking is improved by first obtaining the initialization pose based on the two-dimensional feature point and then optimizing the initialization pose based on the initialization pose and the at least two reference features; furthermore, the initialization pose is calculated without depending on or entirely depending on the light spot feature corresponding to the light emitting unit, and during the process of optimizing the initialization pose, a minimum of two reference features are only required, such that the number of the light emitting units required on the mobile device 10 is reduced, thereby simplifying the structure of the mobile device 10, reducing power consumption, and improving the design diversity of the mobile device 10; in addition, in this embodiment, problems of the accuracy of tracking and the tracking in the complex scenario can be effectively solved under conditions where the light emitting unit 11 of the mobile device 10 is sparse.

In particular, the reference feature is the light spot feature corresponding to the light emitting unit 11 on the acquired actual image of the mobile device 10, that is, the reference feature is the actual light spot feature; and by using the reference feature as reference baseline, the initialization pose is optimized for fine-tuning the initialization pose, to make the light spot feature corresponding to the initialization pose coincide with the reference feature, such that the optimized initialization pose can embody an actual pose of the mobile device 10.

An unique pose of the mobile device 10 can be determined by two points, such that by optimizing the initialization pose based on the initialization pose and the at least two reference features, to make the light spot feature corresponding to the initialization pose coincide with the reference feature, the unique pose of the mobile device 10 can be defined by using the at least two reference features as reference baseline, so as to ensure that the optimized pose information can embody an actual state of the mobile device 10, thereby improving the precision and stability of pose tracking.

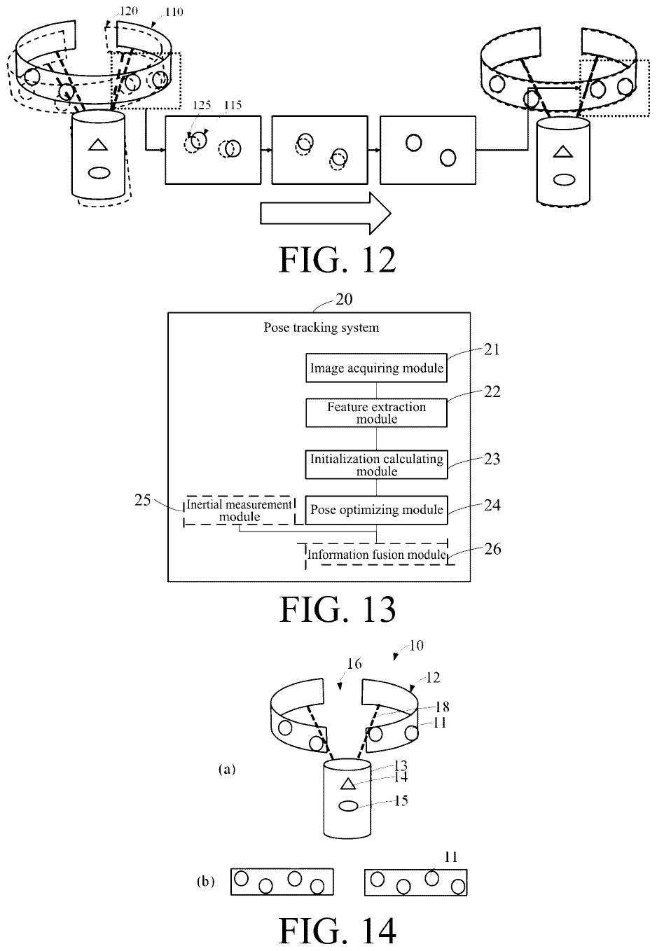

FIG. 12 shows a schematic diagram of a process of an embodiment in which optimization is performed in step S4 in FIG. 7. A solid box 110 is the mobile device 10 in the obtained actual image, and a dashed box 120 is the mobile device 10 in a virtual model image obtained based on the initialization pose.

In combination with FIG. 12, as an example, step S4 of based on the initialization pose and the at least two reference features 115, optimizing the initialization pose comprises: obtaining, based on the initialization pose, the light spot features 125 generated by illumination models of at least two light emitting units 11 of the mobile device 10; and employing an optimization algorithm to optimize the initialization pose for making the light spot feature 125 coincide with the reference feature 115.

In this embodiment, a shape of the mobile device 10 projected on the image at each angle and each distance is calculated by hardware parameters of the mobile device 10, so as to obtain the light spot features 125 generated by the illumination models of the at least two light emitting units 11 of the mobile device 10.

In this embodiment, the initialization pose is optimized by employing the optimization algorithm, and the light spot feature 125 corresponding to the initialization pose is continuously adjusted to make the light spot feature coincide with the reference feature 115, such that precise pose information is obtained.

In this embodiment, the optimization algorithm comprises a Gauss-Newton method or a Levenberg-Marquardt method. The optimization algorithm may also be other types of nonlinear least squares.

In this embodiment, an objective function of the optimization algorithm is as follows:

$$\hat{∅} = {min}_{∅} IOU ( {Mask}_{0} , {Mask}_{1} ( ∅ ) ) ;$$

IOU represents an intersection of the light spot features divided by a union of the light spot features, Mask₀ represents the reference feature extracted from the image, Mask₁ (ø) represents the light spot feature generated by the illumination model of the light emitting unit when a pose is ø, and \hat{ø} represents a pose estimated when the IOU of the light spot feature is minimum.

Accordingly, in this embodiment, during the process of making the light spot feature 125 corresponding to the initialization pose coincide with the reference feature 115, the initialization pose is fine-tuned; and by determining the IOU of the light spot feature 125 and distance between the light spot feature 125 corresponding to the initialization pose and center point coordinates of the reference feature 115, whether the light spot feature 125 corresponding to the initialization pose coincides with the reference feature 115 is determined.

In this embodiment, the pose tracking method further comprises: referring to FIG. 7, executing step S5 of obtaining inertial measurement data of the mobile device 10. The inertial measurement data is acquired to subsequently fuse the inertial measurement data, the optimized initialization pose, and the corresponding light spot feature.

In this embodiment, the inertial measurement data comprises angular velocity information and acceleration information. In this embodiment, the inertial measurement data further comprises gravity information. In particular, during particular implementation, an Inertial Measurement Unit (IMU) is disposed in the mobile device 10, such that the inertial measurement data measured by the inertial measurement unit is acquired.

In particular, the inertial measurement data between a previous frame image time and a current frame image time is acquired.

Referring to FIG. 7, step S6 of, after optimizing the initialization pose based on the initialization pose and the at least two reference features, fusing the inertial measurement data, the optimized initialization pose, and the corresponding light spot feature to obtain pose information of the mobile device, is executed.

In this embodiment, the inertial measurement data, the optimized initialization pose, and the corresponding light spot feature are fused, such that a frame rate of inertial measurement is higher, and an output frequency of a current pose is improved; and by fusing visual information and the inertial measurement data, smoothing filtering is performed on the current pose, such that output jitters are reduced, such that smooth and low-latency pose information is output.

In this embodiment, 6 degrees of freedom pose information is output.

In this embodiment, the inertial measurement data, the optimized initialization pose, and the corresponding light spot feature are fused by using an Extended Kalman Filter (EKF) or a similar extended Kalman filter.

Accordingly, the present invention further provides a pose tracking system. FIG. 13 is a functional block diagram of an embodiment of a pose tracking system of the present invention. FIG. 8 is a schematic structural diagram of an embodiment of a mobile device of the present invention.

In this embodiment, the pose tracking system 20 comprises: an image acquiring module 21 configured to acquire an image of a mobile device 10 whereon is disposed with a light emitting unit 11 for emitting signal light; a feature extraction module 22 configured to, based on the image, extract, as a reference feature, a light spot feature corresponding to the light emitting unit 11 on the image, and extract a two-dimensional feature point corresponding to a three-dimensional feature point of the mobile device 10 in the image; an initialization calculating module 23 configured to obtain an initialization pose of the mobile device 10 based on the two-dimensional feature point; and a pose optimizing module 24 configured to, based on the initialization pose and the at least two reference features, optimize the initialization pose for adjusting the initialization pose, to make the light spot feature corresponding to the initialization pose coincide with the reference feature.

The image acquiring module 21 acquires the image of the mobile device 10, so as to track a pose of the mobile device 10 at an image time based on the image. In particular, the feature extraction module 22 extracts the light spot feature corresponding to the light emitting unit 11 on the image based on the image, and extracts the two-dimensional feature point corresponding to the three-dimensional feature point of the mobile device 10 in the image. Accordingly, the image comprises a light spot corresponding to the light emitting unit 11.

The mobile device 10 is an apparatus that can move and is to be subjected to pose tracking. In this embodiment, the plurality of light emitting units 11 are disposed on the mobile device 10, and the light emitting unit 11 is configured to emit the signal light to form the corresponding light spot in the image, such that the feature extraction module 22 conveniently extracts, based on the image, the light spot feature corresponding to the light emitting unit 11.

In particular, referring to FIG. 8, in this embodiment, the mobile device 10 comprises a positioning component 12, and the plurality of light emitting units 11 are distributed on the positioning component 12. The positioning component 12 is configured to mount and distribute the light emitting units 11.

As an example, the mobile device 10 is a handheld controller. For example, the mobile device 10 is the handheld controller applied to VR, AR or MR.

In this embodiment, the handheld controller comprises a lamp ring, that is, the positioning component 12 of the handheld controller is of an annular structure, and the lamp ring is provided with the plurality of light emitting units 11. During particular implementation, the light emitting unit 11 may be an LED lamp. In other embodiments, the mobile device may also be other pose tracking apparatus with LED lamps or reflective balls.

As an example, the mobile device 10 is configured to be cooperatively used with a tracking display device (not shown in the figure), and the image acquiring module 21 configured to collect the image of the mobile device 10 is disposed in the tracking display device, and the feature extraction module 22, the initialization calculating module 23, and the pose optimizing module 24 are also disposed to calculate the pose of the mobile device 10 based on the collected image; and the tracking display device is also provided with a display end, and after the pose of the mobile device 10 is obtained, such that display content of the display end is updated based on pose information of the mobile device 10.

For example, the mobile device 10 is the handheld controller applied to VR, AR or MR, and the tracking display device is a head-mounted display apparatus cooperatively used with the handheld controller. In particular, the head-mounted display apparatus may be a pair of VR, AR or MR smart glasses.

As an example, the image of the mobile device 10 is acquired by an image acquisition device disposed on the tracking display device. As an example, the image acquisition device may be a camera unit. During particular implementation, the camera unit may be an infrared (IR) camera, a grayscale camera, a color camera, etc. During particular implementation, there may be one or more camera units.

The feature extraction module 22 extracts, as the reference feature, the light spot feature corresponding to the light emitting unit 11 on the image, such that, after the initialization calculating module 23 obtains the initialization pose, the pose optimizing module 24 can optimize the initialization pose based on the initialization pose and the at least two reference features. During the process of optimization, the at least two reference features are used as reference baseline for the light spot feature corresponding to the initialization pose, such that the light spot feature corresponding to the initialization pose can coincide with the reference feature.

During particular implementation, the light spot is generally circular or oval-shaped. The light spot feature comprises shapes of various light spots, such that positions of the light spots and the distribution of the light spots are determined.

The feature extraction module 22 extracts the two-dimensional feature point corresponding to the three-dimensional feature point of the mobile device 10 in the image for calculating the initialization pose of the mobile device 10, such that the initialization calculating module 23 can calculate the initialization pose without depending on or entirely depending on the light spot feature corresponding to the light emitting unit 11, thereby reducing the number of the light emitting units 11 required on the mobile device 10.

In this embodiment, the three-dimensional feature point refers to a feature point corresponding to the mobile device 10 in a three-dimensional space, and is used for marking a position and state of the mobile device 10 in the three-dimensional space. Accordingly, the two-dimensional feature point refers to a feature point corresponding to the three-dimensional feature point in the acquired image of the mobile device 10.

In this embodiment, a selection method of the three-dimensional feature point comprises: taking, as the three-dimensional feature point, each vertex of a smallest three-dimensional bounding frame of a three-dimensional model of the mobile device 10. The three-dimensional bounding frame refers to a cuboid bounding frame that surrounds the mobile device 10.

According to a shape rule of the smallest three-dimensional bounding frame, a position of the vertex is easily determined and calculated, and in this embodiment, the two-dimensional feature point corresponding to the three-dimensional feature point in the image is easily determined by selecting each vertex of the smallest three-dimensional bounding frame, and the initialization pose is easily calculated subsequently based on the two-dimensional feature point.

In other embodiments, the three-dimensional feature point may also be a point on the mobile device, and the selection method of the three-dimensional feature point may further comprise: selecting a plurality of pivotal points on the three-dimensional model of the mobile device as the three-dimensional feature points. In this embodiment, the number of the three-dimensional feature points is at least four, so as to meet a number requirement for calculating a smallest feature point of the initialization pose.

For example, when the mobile device comprises the positioning component, the positioning component is distributed with the plurality of light emitting units, the positioning component is of the annular structure, and one or more notches are provided at positions other than the light emitting units on the positioning component, a corner vertex of the notch may be selected as the three-dimensional feature point. In some other embodiments, other pivotal points on the mobile device may also be selected as the three-dimensional feature points based on an actual shape of the mobile device and actual requirements.

In this embodiment, the feature extraction module 22 comprises: a training data acquisition unit (not shown in the figure) configured to acquire training data, wherein the training data comprises the image of the mobile device 10 and a corresponding label, and the label comprises the light spot feature corresponding to the light emitting unit 11 on the image and the two-dimensional feature point corresponding to the three-dimensional feature point of the mobile device 10 in the image; a training unit (not shown in the figure) configured to train a deep learning network 100 by using the training data, so as to obtain a trained deep learning network 100; and an inference unit (not shown in the figure) configured to perform inference based on the image and the deep learning network, to obtain, as the reference feature, the light spot feature corresponding to the light emitting unit on the image, and to obtain the two-dimensional feature point corresponding to the three-dimensional feature point of the mobile device in the image.

The training data acquisition unit acquires the training data to allow the training unit to train the deep learning network, such that the trained deep learning network is obtained. As an example, during particular implementation, the training data acquisition unit may use an automatic labeling system or a manual labeling system to generate the training data.

The trained deep learning network 100 is configured to extract the reference feature and the two-dimensional feature point.

FIG. 10 shows a schematic structural diagram of an embodiment of the deep learning network 100, a structure of the deep learning network 100 comprises: an encoder 101 for inputting the image of the mobile device 10; a decoder 102 connected with an output of the encoder 101; a first convolutional structure 103 connected with an output of the decoder 102; a feature point feature extraction module 104 for outputting a predicted coordinate value of the two-dimensional feature point; a second convolutional structure 105 connected with the output of the decoder 102; and a light spot feature extraction module 106 for outputting the light spot feature.

As an example, the encoder 101 may select a network structure such as Resnet, repvgg, mobilenet, etc. As an example, the decoder 102 uses a deconvolution structure, which is configured to improve feature resolution extracted by the encoder 101. During particular implementation, there may be a short connection structure between the decoder and the encoder, and the short connection structure refers to a plurality of connection layers or addition layers during deep learning, and is configured to realize the combination of a decoder feature and an encoder feature.

During particular implementation, the deep learning network may be trained by using an optimizer such as an Adam optimizer, an SGD optimizer, etc.

In this embodiment, the training unit comprises: a regression loss calculation block (not shown in the figure) configured to use the training data to train the deep learning network, comprising: calculating, as a regression loss, a residual between the predicted coordinate value of the two-dimensional feature point and a true value of the coordinate value of the two-dimensional feature point; a mask loss calculation block (not shown in the figure) configured to calculate, as a mask loss, a residual between the output light spot feature and a real light spot feature; and an optimization block (not shown in the figure) configured to use a loss function L=L0+αL1 to train the deep learning network, wherein L0 is the mask loss, L1 is the regression loss, and α is a weight of the regression loss function in the loss function.

In this embodiment, when the training unit trains the deep learning network, the extraction of the light spot feature and the regression of the two-dimensional feature point are trained together, such that information can be additionally provided to the deep learning network by using a multi-task structure, thereby improving a feature extraction effect under a complex scenario.

During particular implementation, when the training unit trains the deep learning network by using the training data, a plurality of data augmentation methods may be used, and the extraction of the light spot feature and the regression of the two-dimensional feature point are trained together, such that a training dataset is increased to make the dataset to be as diverse as possible, so as to make a trained model have a stronger generalization capability.

In this embodiment, the light spot feature corresponding to the light emitting unit 11 on the image and the two-dimensional feature point are obtained by means of the deep learning network, such that the information can be additionally provided to the deep learning network by using the multi-task structure, thereby improving the feature extraction effect under the complex scenario.

In particular, as shown in FIG. 11, the inference unit inputs the image into the trained deep learning network, and then the light spot feature and the two-dimensional feature point are output.

The initialization calculating module 23 obtains the initialization pose, such that the pose optimizing module 24 optimizes the initialization pose, so as to improve the precision of pose tracking. In this embodiment, the initialization calculating module 23 calculates the initialization pose without depending on or entirely depending on the light spot feature corresponding to the light emitting unit 11, such that the number of the light emitting units 11 required on the mobile device 10 is reduced.

In this embodiment, the step of obtaining the initialization pose of the mobile device 10 based on the two-dimensional feature point comprises: based on a corresponding relationship between the two-dimensional feature point and the three-dimensional feature point, using a PnP algorithm to obtain the initialization pose of the mobile device 10.

The pose optimizing module 24 optimizes, based on the initialization pose and the at least two reference features 115, the initialization pose for fine-tuning the initialization pose, to make the light spot feature 125 corresponding to the initialization pose coincide with the reference feature 115.

In this embodiment, the initialization calculating module 23 obtains the initialization pose based on the two-dimensional feature point, the pose optimizing module 24 optimizes the initialization pose based on the initialization pose and the at least two reference features, such that the precision of pose tracking is improved; furthermore, the initialization calculating module 23 calculates the initialization pose without depending on or entirely depending on the light spot feature corresponding to the light emitting unit 11, and during the process that the pose optimizing module 24 optimizes the initialization pose, a minimum of two reference features are only required, such that the number of the light emitting units 11 required on the mobile device 10 is reduced, thereby simplifying the structure of the mobile device 10, reducing power consumption, and improving the design diversity of the mobile device 10; in addition, in this embodiment, problems of the accuracy of tracking and the tracking in the complex scenario can be effectively solved under conditions where the light emitting unit 11 of the mobile device 10 is sparse.

In particular, the reference feature is the light spot feature corresponding to the light emitting unit 11 on the acquired actual image of the mobile device 10, that is, the reference feature is the actual light spot feature; and by using the reference feature as baseline, the initialization pose is optimized for fine-tuning the initialization pose, to make the light spot feature corresponding to the initialization pose coincide with the reference feature, such that the optimized initialization pose can embody an actual pose of the mobile device, thereby improving the precision of pose tracking.

An unique pose of the mobile device can be determined by two points, the pose optimizing module 24 optimizes the initialization pose based on the initialization pose and the at least two reference features, to make the light spot feature corresponding to the initialization pose coincide with the reference feature, such that the unique pose of the mobile device 10 can be defined by using the at least two reference features as reference baseline, so as to ensure that the optimized pose information can embody an actual state of the mobile device 10, thereby improving the precision and stability of pose tracking.

FIG. 12 shows a schematic diagram of a process of an embodiment in which the pose optimizing module 24 performs optimization. A solid box 110 is the mobile device 10 in the obtained actual image, and a dashed box 120 is the mobile device 10 in a virtual model image obtained based on the initialization pose.

In combination with FIG. 12, as an example, the pose optimizing module 24 comprises: a light spot generation unit (not shown in the figure) configured to, obtain, based on the initialization pose, the light spot features 125 (as shown in FIG. 12) generated by illumination models of at least two light emitting units 11 of the mobile device 10; and a pose optimizing unit (not shown in the figure) configured to employ an optimization algorithm to optimize the initialization pose for making the light spot feature 125 coincide with the reference feature 115.

In this embodiment, the light spot generation unit calculates a shape of the mobile device 10 projected on the image at each angle and each distance by hardware parameters of the mobile device 10, so as to obtain the light spot features 125 generated by the illumination models of the at least two light emitting units 11 of the mobile device 10.

In this embodiment, the pose optimizing unit optimizes the initialization pose by employing the optimization algorithm, and the light spot feature 125 corresponding to the initialization pose is continuously adjusted to make the light spot feature coincide with the reference feature 115, such that precise pose information is obtained. In this embodiment, the optimization algorithm comprises a Gauss-Newton method or a Levenberg-Marquardt method. In other embodiments, the optimization algorithm may also be other types of nonlinear least squares.

In this embodiment, an objective function of the optimization algorithm is as follows:

$$\hat{∅} = {min}_{∅} IOU ( {Mask}_{0} . {Mask}_{1} ( ∅ ) ) ;$$

IOU represents an intersection of the light spot features divided by a union of the light spot features, Mask₀ represents the reference feature extracted from the image, Mask₁ (ø) represents the light spot feature generated by the illumination model of the light emitting unit when a pose is ø, and \hat{ø} represents a pose estimated when the IOU of the light spot feature is minimum.

Accordingly, in this embodiment, during the process of making the light spot feature 125 corresponding to the initialization pose coincide with the reference feature 115, the initialization pose is fine-tuned; and by determining the IOU of the light spot feature and distance between the light spot feature 125 corresponding to the initialization pose and center point coordinates of the reference feature 115, whether the light spot feature 125 corresponding to the initialization pose coincides with the reference feature 115 is determined.

In this embodiment, the pose tracking system 20 further comprises: an inertial measurement module 25 configured to obtain the inertial measurement data of the mobile device 10, so as to fuse the inertial measurement data, the optimized initialization pose, and the corresponding light spot feature.

In this embodiment, the inertial measurement data comprises angular velocity information and acceleration information. In this embodiment, the inertial measurement data further comprises gravity information. In particular, during particular implementation, an inertial measurement unit is disposed in the mobile device 10, and the inertial measurement data measured is acquired by the inertial measurement unit disposed in the mobile device 10.

In particular, the inertial measurement data between a previous frame image time and a current frame image time is acquired.

In this embodiment, the pose tracking system 20 further comprises: an information fusion module 26 configured to fuse the inertial measurement data, the optimized initialization pose, and the reference feature, so as to obtain pose information of the mobile device.

In this embodiment, a frame rate of inertial measurement is higher, the inertial measurement data, the optimized initialization pose, and the corresponding light spot feature are fused, such that an output frequency of a current pose is improved; and by fusing visual information and the inertial measurement data, smoothing filtering is performed on the current pose, such that output jitters are reduced, such that smooth and low-latency pose information is output.

In this embodiment, 6 degrees of freedom pose information is output. In this embodiment, the information fusion module 26 fuses the inertial measurement data, the optimized initialization pose, and the corresponding light spot feature by using an extended Kalman filter or a similar extended Kalman filter.

Accordingly, the embodiments of the present invention further provides a mobile device. FIG. 8 is a schematic structural diagram of an embodiment of a mobile device of the present invention.

In this embodiment, the pose information of the mobile device 10 is calculated by using the pose tracking method of the embodiments of the present invention; and the mobile device 10 comprises: a positioning component 12 on which a plurality of light emitting units 11 for emitting signal light are distributed, and the light emitting units 11 are configured to be able to see at least two light emitting units 11 from various angles simultaneously.

From the aforementioned records, it can be learned that, according to the pose tracking method of the embodiments of the present invention, the precision of pose tracking is improved by first obtaining the initialization pose based on the two-dimensional feature point and then optimizing the initialization pose based on the initialization pose and the at least two reference features; furthermore, the initialization pose is calculated without depending on or entirely depending on the light spot feature corresponding to the light emitting unit 11, and during the process of optimizing the initialization pose, a minimum of two reference features are only required, such that the number of the light emitting units required on the mobile device 10 is reduced, thereby simplifying the structure of the mobile device 10, reducing power consumption, and improving the design diversity of the mobile device.

In addition, in this embodiment, the light emitting units 11 are configured such that at least two light emitting units 11 can be seen simultaneously from all angles, therefore, when the mobile device 10 performs pose tracking, the light spots corresponding to the at least two light emitting units 11 can be at least captured, such that pose tracking is conveniently performed in the embodiments of the present invention, so as to achieve the purpose of improving the precision of pose tracking and reducing the number of the light emitting units.

In this embodiment, the mobile device 10 is an apparatus that can move and is to be subjected to pose tracking. In this embodiment, the plurality of light emitting units 11 are disposed on the mobile device 10, and the light emitting unit 11 is configured to emit the signal light to form the corresponding light spot in the image, such that the light spot feature corresponding to the light emitting unit 11 is extracted based on the image of the mobile device 10.

As an example, the mobile device 10 is a handheld controller. For example, the mobile device 10 is the handheld controller applied to VR, AR or MR. In other embodiments, the mobile device may also be other mobile pose tracking apparatus with LED lamps or reflective balls.

The positioning component 12 is configured to mount and distribute the light emitting units 11. In this embodiment, the positioning component 12 is of an annular structure, such that the light emitting unit 11 can be captured from all the angles.

As an example, the handheld controller comprises a lamp ring, that is, the positioning component 12 of the handheld controller is of an annular structure, and the lamp ring is provided with the plurality of light emitting units 11. During particular implementation, the light emitting unit 11 may be an LED lamp.

In this embodiment, one or more notches 16 are provided at positions other than the light emitting units 11 on the positioning component 12. By providing one or more notches 16 on the positioning component 12, the weight of the positioning component 12 is further reduced, the weight of the mobile device 10 is further reduced accordingly, and the structural design diversity of the mobile device 10 is improved as well. Furthermore, by providing one or more notches 16, the notches 16 of the plurality of mobile devices 10 (for example, handheld controllers corresponding to left and right hands) may also be snapped with each other to realize interaction, or by using the design of the notches 16, a hand may reach over the positioning component 12 more easily, such that more functional design and morphological design possibilities are provided.

As an example, the notch 16 separates adjacent ends of the annular structure, such that the weight of the positioning component 12 is further reduced, and the interaction between the mobile devices 10, and between the mobile device 10 and a human hand is realized.

FIG. 14 shows a schematic structural diagram of another embodiment of a mobile device 10 of the present invention. In this embodiment, there may be one (as shown in FIG. 8) or more (as shown in FIG. 14) notches 16.

In this embodiment, the mobile device 10 further comprises a control component 13 connected with the positioning component 12. The control component 13 is configured to interact with the human hand, so as to achieve particular actions and functions.

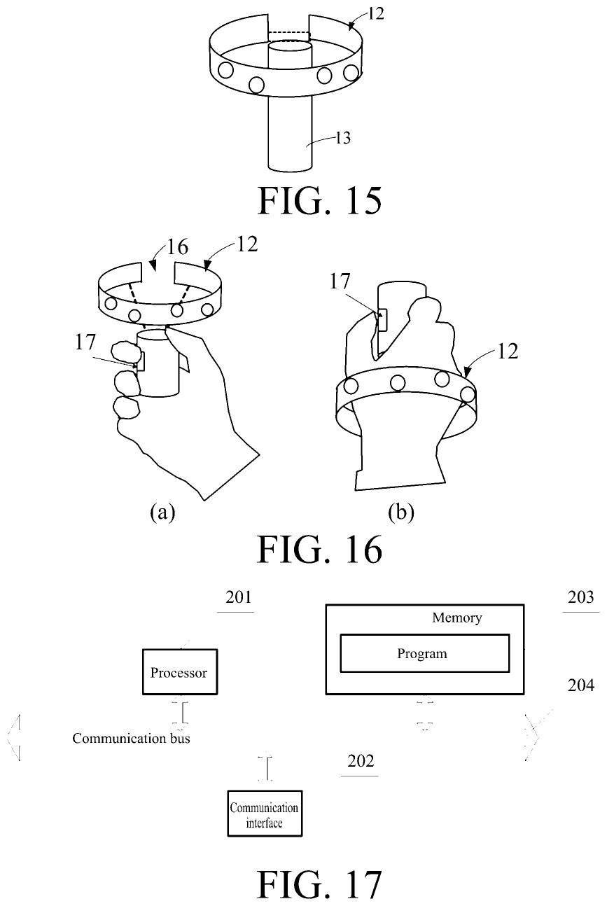

During particular implementation, the control component 13 and the positioning component 12 may be connected in a plurality of manners, and have a plurality of positional relationships. For example, as shown in FIGS. 8 and 14, the control component 13 and the positioning component 12 are connected by means of a connection rod 18, and the positioning component 12 is of an annular structure and away from a tail end of the control component 13; alternatively, as shown in FIG. 15, the positioning component 12 is of the annular structure, and the positioning component 12 is tangent with and connected with the tail end of the control component 13.

During particular implementation, the positioning component 12 and the control component 13 may also be of an integral structure. When the positioning component 12 is of the annular structure, and the positioning component 12 is tangent with and connected with the tail end of the control component 13, a plane defined by the annular structure may be perpendicular to or has an included acute angle with an extending direction of the control component 13.

In this embodiment, the control component 13 is disposed with an inertial measurement unit 14 and an information transmission unit 15.

In this embodiment, the inertial measurement unit 14 is configured to measure inertial measurement data, and the information transmission unit 15 is configured to transmit the inertial measurement data to a tracking display device, so as to fuse the inertial measurement data, an optimized initialization pose, and a corresponding light spot feature.

Detailed descriptions for content of the inertial measurement unit 14, the tracking display device, and fusion refer to corresponding descriptions of the aforementioned embodiments, and are not described in this embodiment again.

FIG. 16 shows a schematic diagram of two use states of a mobile device. FIG. 16(a) is a schematic diagram of a normal use state of the mobile device, and FIG. 16(b) is a schematic diagram of a use state of the mobile device gripped upside down.

As shown in FIG. 16, in this embodiment, the control component 13 is provided with one or more function keys 17, and the function key 17 can realize a particular operation when being pressed. For example, the function key 17 can realize the grabbing or loosening an object when being pressed.

As shown in FIG. 16, through the design of the notch 16, when a user uses the mobile device 10, the hand may pass through the annular positioning component 12 more easily, such that more functional designs are realized. For example, as shown in FIG. 16(b), when the mobile device 10 is gripped upside down, such use state can make the mobile device 10 not easy to drop when the mobile device 10 is used; and a gesture can only be used by generally putting down the mobile device 10 in the normal use state, and the use state shown in FIG. 16(b) facilitates the release of the mobile device 10 at any time, such that the gesture can be switched more quickly.

It is further to be noted that, in this embodiment, the mobile device 10 is configured to be used cooperatively with a tracking display device (not shown in the figure), which collects an image of the mobile device 10, and the image is used for analyzing a positional relationship between a wrist and the positioning component 12; and the function key 17 can switch corresponding functions in combination with the positional relationship; alternatively, the function key 17 is able to switch the corresponding functions when being continuously pressed.

By switching the functions of the function key 17, the function key 17 can be reused when the mobile device 10 is in different use states, so as to provide more possibilities for realizing the functions.

The image of the mobile device 10 is acquired by an image acquisition device (for example, a camera unit) disposed on the tracking display device. During particular implementation, the positional relationship between the wrist and the positioning component 12 may be analyzed through the image, such that the state in which the mobile device 10 is gripped is determined, to determine whether the mobile device 10 is in the normal use state or the state of being gripped upside down, so as to switch the functions of the function key 17.

In order to solve the problem, the embodiments of the present invention further provides an electronic device. The electronic device may implement the pose tracking method provided by the embodiments of the present invention by loading the pose tracking method in the form of a program.

From the aforementioned records, it can be learned that, in the pose tracking method provided by the embodiments of the present invention, the feature of the light emitting unit is extracted as the reference feature based on the image, the feature points on the mobile device are extracted, the initialization pose is obtained based on the two-dimensional feature point, and then the initialization pose is optimized based on the initialization pose and the at least two reference features, such that the precision of pose tracking is improved; furthermore, the initialization pose is calculated without depending on or entirely depending on the light spot feature corresponding to the light emitting unit, and during the process of optimizing the initialization pose, a minimum of two reference features are only required, such that the number of the light emitting units required on the mobile device is reduced, thereby simplifying the structure of the electronic device provided by this embodiment, reducing power consumption, improving the design diversity of the electronic device, and accordingly improving user experience.

In this embodiment, the electronic device comprises a tracking display device and a mobile device. The mobile device is an apparatus that can move and is to be subjected to pose tracking. During particular implementation, the mobile device is cooperatively used with the tracking display device to obtain the pose of the mobile device, so as to update display content of a display end based on the pose of the mobile device.

For example, the mobile device is a handheld member applied to VR, AR or MR, and the tracking display device is a head-mounted display apparatus cooperatively used with the handheld member. In particular, as an example, the head-mounted display device may be a pair of VR, AR or MR smart glasses.

Accordingly, as an example, the apparatus provided in this embodiment is a head-mounted all-in-one including a handheld controller. For example, the apparatus comprises a head-mounted 6DoF all-in-one, etc.

An optional hardware structure of the electronic device provided by the embodiments of the present invention may be shown in FIG. 17, and comprises at least one processor 201, at least one communication interface 202, at least one memory 203, and at least one communication bus 204. In the embodiments of the present invention, at least one processor 201, at least one communication interface 202, at least one memory 203, and at least one communication bus 204 are provided, and the processor 201, the communication interface 202, and the memory 203 communicate with each other by using the communication bus 204.

Optionally, the communication interface 202 may be an interface of a communication module configured to perform network communication, for example, an interface of a GSM module. Optionally, the processor 201 may be a central processing unit CPU, or an Application Specific Integrated Circuit (ASIC), or one or more integrated circuits configured to implement the embodiments of the present invention. Optionally, the memory 203 may comprise a high-speed RAM, or may further comprise a non-volatile memory, for example, at least one magnetic disk memory. The memory 203 stores one or more computer instructions. The one or more computer instructions are executed by the processor 201 to implement the pose tracking method provided by the embodiments of the present invention.

It is to be noted that, above-mentioned implementation terminal apparatus may further comprise other devices (not shown) that may not be essential to the disclosure of the embodiments of the present invention; and in view of the fact that these other devices may not be essential to understand the disclosure of the embodiments of the present invention, the embodiments of the present invention do not present each of them in this regard.

Accordingly, the embodiments of the present invention further provide a storage medium. The storage medium stores one or more computer instructions. The one or more computer instructions are used for implementing the pose tracking method described in the embodiments of the present invention.

The storage medium is a computer-readable storage medium. The storage medium may comprise various media capable of storing program codes such as a Read-Only Memory (ROM), a Random Access Memory (RAM), U disk, a mobile hard disk, a magnetic disk or an optical disk.

The above-mentioned implementations of the present invention are combinations of elements and features of the present invention. Unless otherwise mentioned, the elements or features may be considered optional. Each of the elements or features may be practiced without being combined with other elements or features. In addition, the implementations of the invention may be constructed by combining some of the elements and/or features. The order of operations described in the implementations of the present invention may be rearranged. Some of the constructions of either implementation may be comprised in the other implementation and may be replaced with corresponding constructions of the other implementation. It would be apparent to those skilled in the art that, claims of the appended claims that are not explicitly referenced in relation to one another may be combined in implementations of the present invention or may be comprised as new claims in an amendment subsequent to the filing of the present application.

The implementations of the present invention may be implemented by various means such as hardware, firmware, software, or a combination thereof. In a hardware configuration approach, the method according to the exemplary implementations of the present invention may be implemented by one or more application specific integrated circuits (ASIC), digital signal processors (DSP), digital signal processing devices (DSPD), programmable logic devices (PLD), field programmable gate arrays (FPGA), processors, controllers, micro-controllers, microprocessors, etc.

In a firmware or software configuration approach, the implementations of the present invention may be implemented in the form of modules, processes, functions, etc. A software code may be stored in a memory cell and be executed by a processor. The memory cell is located inside or outside the processor, and sends data to the processor or receives the data from the processor via various known means.

Although the present invention is disclosed as above, the present invention is not limited thereto. Any person skilled in the art may make respective changes and modifications without departing from the spirit and scope of the present invention. Therefore, the protection scope of the present invention should be subject to the scope defined by the claims.

1. A pose tracking method comprising:
acquiring an image of a mobile device whereon is disposed with a light emitting unit for emitting signal light;
based on the image, extracting, as a reference feature, a light spot feature corresponding to the light emitting unit on the image, and extracting a two-dimensional feature point corresponding to a three-dimensional feature point of the mobile device in the image;
obtaining an initialization pose of the mobile device based on the two-dimensional feature point; and
based on the initialization pose and the at least two reference features, adjusting the initialization pose.

2. The pose tracking method of claim 1, further comprising:
obtaining, based on the initialization pose, the light spot features generated by illumination models of at least two light emitting units of the mobile device; and
employing an optimization algorithm to adjust the initialization pose for making the light spot feature coincide with the reference feature.

3. The pose tracking method of claim 2, wherein an objective function of the optimization algorithm is as follows:
$$\hat{∅} = {min}_{∅} IOU ( {Mask}_{0} , {Mask}_{1} ( ∅ ) ) ;$$
wherein IOU represents an intersection of the light spot features divided by a union of the light spot features, Mask₀ represents the reference feature extracted from the image,
Mask₁ (ø) represents the light spot feature generated by the illumination model of the light emitting unit when a pose is ø, and \hat{ø} represents a pose estimated when the IOU of the light spot feature is minimum.

4. The pose tracking method of claim 2, wherein the optimization algorithm comprises a Gauss-Newton method or a Levenberg-Marquardt method.

5. The pose tracking method of claim 1, further comprising:
acquiring training data that comprises the image of the mobile device and a corresponding label, wherein the label comprises the light spot feature corresponding to the light emitting unit on the image and the two-dimensional feature point corresponding to the three-dimensional feature point of the mobile device in the image;
using the training data to train a deep learning network, to obtain a trained deep learning network; and
based on the image and the deep learning network, performing inference to obtain, as the reference feature, the light spot feature corresponding to the light emitting unit on the image, and to obtain the two-dimensional feature point corresponding to the three-dimensional feature point of the mobile device in the image.

6. The pose tracking method of claim 5, further comprising:
taking, as the three-dimensional feature point, each vertex of the smallest three-dimensional bounding frame of a three-dimensional model of the mobile device; or
selecting, as the three-dimensional feature points, multiple pivotal points on the three-dimensional model of the mobile device.

7. The pose tracking method of claim 5, wherein a structure of the deep learning network comprises: an encoder for inputting the image of the mobile device; a decoder connected with an output of the encoder; a first convolutional structure connected with an output of the decoder; a feature point feature extraction module for outputting a predicted coordinate value of the two-dimensional feature point; a second convolutional structure connected with the output of the decoder; and a light spot feature extraction module for outputting the light spot feature; and
further comprising:
calculating, as a regression loss, a residual between the predicted coordinate value of the two-dimensional feature point and a true value of the coordinate value of the two-dimensional feature point; calculating, as a mask loss, a residual between the output light spot feature and a real light spot feature; and using a loss function L=L0+αL1 to train the deep learning network;
wherein L0 is the mask loss, L1 is the regression loss, and α is a weight of the regression loss function in the loss function.

8. The pose tracking method of claim 1, further comprising: based on a corresponding relationship between the two-dimensional feature point and the three-dimensional feature point, using a PnP algorithm to obtain the initialization pose of the mobile device.

9. The pose tracking method of claim 1, further comprising:
obtaining inertial measurement data of the mobile device; and
after adjusting the initialization pose based on the initialization pose and the at least two reference features, fusing the inertial measurement data, the adjusted initialization pose, and the corresponding reference feature to obtain pose information of the mobile device.

10. The pose tracking method of claim 9, wherein the inertial measurement data, the optimized initialization pose, and the corresponding light spot feature are fused by using an extended Kalman filter or a similar extended Kalman filter.

11. A pose tracking system, comprising:
an image acquiring module configured to acquire an image of a mobile device whereon is disposed with a light emitting unit for emitting signal light;
a feature extraction module configured to, based on the image, extract, as a reference feature, a light spot feature corresponding to the light emitting unit on the image, and extract a two-dimensional feature point corresponding to a three-dimensional feature point of the mobile device in the image;
an initialization calculating module configured to obtain an initialization pose of the mobile device based on the two-dimensional feature point; and
a pose optimizing module configured to, based on the initialization pose and the at least two reference features, optimize the initialization pose for adjusting the initialization pose, to make the light spot feature corresponding to the initialization pose coincide with the reference feature.

12. The pose tracking system of claim 11, further comprising: an information fusion module configured to fuse inertial measurement data output by the mobile device, the optimized initialization pose, and the corresponding reference feature, to obtain pose information of the mobile device.

13-20. (canceled)
